(19) United States
(12) Patent Application Publication
(10) Pub. No.: US 2020/0249902 A1
(43) Pub. Date: Aug. 6, 2020

(54) INFORMATION PROCESSING SYSTEM, INFORMATION PROCESSING APPARATUS, AND METHOD OF PROCESSING INFORMATION

(71) Applicant: DAIGO TAGUCHI, Kanagawa (JP)

(72) Inventor: DAIGO TAGUCHI, Kanagawa (JP)

(73) Assignee: Ricoh Company, Ltd., Tokyo (JP)

(21) Appl. No.: 16/744,454

(22) Filed: Jan. 16, 2020

(30) Foreign Application Priority Data
Jan. 31, 2019 (JP) 2019-016351

(51) Int. Cl. G06F 3/14; H04L 12/18; H04L 29/08

(52) U.S. Cl. CPC G06F 3/1454; H04L 12/1827; H04L 67/025; H04L 12/1831

(57) ABSTRACT

An information processing system includes one or more information processing apparatuses each being configured to control a plurality of communication terminals to perform screen sharing by using web browsers installed in the plurality of communication terminals. The one or more information processing apparatuses each includes circuitry configured to receive a selection of a file to be screen-shared from one of the plurality of communication terminal, and display a history of the file that is screen-shared on a shared web page, the shared web page being a web page editable from the web browsers of the plurality of communication terminals.

### CROSS-REFERENCE TO RELATED APPLICATION

This patent application is based on and claims priority pursuant to 35 U.S.C. § 119(a) to Japanese Patent Application No. 2019-016351, filed on Jan. 31, 2019, in the Japan Patent Office, the entire disclosure of which is hereby incorporated by reference herein.

### BACKGROUND

### Technical Field

The present disclosure relates to an information processing system, an information processing apparatus, and a method of processing information.

### Description of the Related Art

For example, remote conference systems are known that connect different remote sites to implement remote collaborative work. In remote conference systems of the related art, a user uploads materials stored in an information terminal operated by the user to an information processing server so that the material can be shared by participants of the remote meeting, and the shared materials are projected onto an electronic whiteboard or using a projector.

### SUMMARY

According to an embodiment, an information processing system includes one or more information processing apparatuses each being configured to control a plurality of communication terminals to perform screen sharing by using web browsers installed in the plurality of communication terminals. The one or more information processing apparatuses each includes circuitry configured to receive a selection of a file to be screen-shared from one of the plurality of communication terminal, and display a history of the file that is screen-shared on a shared web page, the shared web page being a web page editable from the web browsers of the plurality of communication terminals.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a system configuration of an information processing system, according to an embodiment of the present disclosure;

FIG. 2 is a block diagram illustrating an example of a hardware configuration of a computer, according to an embodiment of the present disclosure;

FIG. 3 is a schematic diagram illustrating an overview of how the information processing system operates during a meeting, according to an embodiment of the present disclosure;

FIG. 4 is an example illustration for explaining a screen sharing function, according to an embodiment of the present disclosure;

FIG. 5 is an example illustration for explaining a shared board function and a personal board function, according to an embodiment of the present disclosure;

FIG. 6 is a block diagram illustrating an example of a functional configuration of the information processing system, according to an embodiment of the present disclosure;

FIG. 7 is a sequence diagram illustrating an example of operation executed by the information processing system, according to an embodiment of the present disclosure;

FIG. 8A and FIG. 8B are diagrams, each illustrating an example of a screen of a personal board, according to an embodiment of the present disclosure;

FIG. 9A and FIG. 9B are diagrams, each illustrating an example of a screen of a shared board, according to an embodiment of the present disclosure;

FIG. 10 is a flowchart illustrating an example of operation of acquiring file configuration information from a cloud storage service, performed by a content management server, according to an embodiment of the present disclosure; and

FIG. 11 is a diagram illustrating a display example of a personal portal screen, according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of the present disclosure are described in detail below, with reference to the drawings. Although a description given hereinafter is of an example of an information processing system used in a meeting. However, this is just an example, and the embodiments are applied to various kinds of information processing system that implements screen sharing among a plurality of communication terminals.

### First Embodiment

System Configuration:

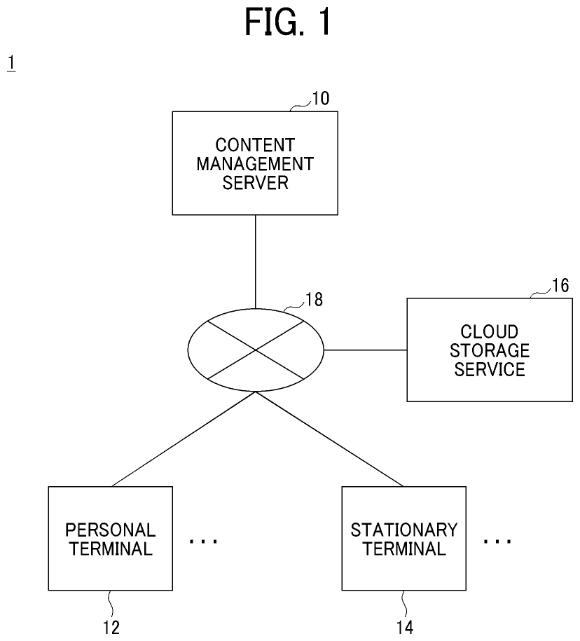

A system configuration of an information processing system 1 according to the present embodiment is described with reference to FIG. 1. FIG. 1 is a diagram illustrating an example of a system configuration of the information processing system 1 according to the present embodiment.

The information processing system 1 illustrated in FIG. 1 includes, for example, a content management server 10, a personal terminal 12, a stationary terminal 14, and a cloud storage service 16, which are communicably connected through a wide area network 18 such as the Internet.

The content management server 10 is implemented by one or more information processing apparatuses. The content management server 10 provides a screen sharing function, a shared board function, and a personal board function, which will be described later, through the network 18. The personal terminal 12 is a computer that a meeting participant can use individually or exclusively and whose screen is viewed by the participant individually. The personal terminal 12 is not limited to being privately-owned. The personal terminal 12 may be public, private, non-profit, rental or any other type of ownership terminal in which a participant may individually or exclusively use the terminal and whose screen is viewed by the participant individually. The stationary terminal 14 is a computer that plural meeting participants can use together and whose screen is viewed by the plural participants. The cloud storage service 16 is a service that offers storage capacity (cloud storage) for storing files to a user such as a meeting participant through the network 18. The cloud storage service 16 may also referred to as an “online storage service”.

Examples of the personal terminal 12 and the stationary terminal 14 include, but not limited to, a laptop computer, a desktop personal computer (PC), a mobile phone, a smartphone, a tablet terminal, and a wearable PC. For example, each of the personal terminal 12 and the stationary terminal 14 includes an image forming apparatus, a projector (PJ), an interactive white board (IWB), which is an electronical whiteboard with mutual communication capability, an output device such as a digital signage, a head-up display (HUD) device, an industrial machine, an imaging device, a sound collecting device, a medical device, a networked home appliance, a game console, a personal digital assistant (PDA), and a digital camera. Each of the personal terminal 12 and the stationary terminal 14 is an example of a communication terminal (or an information processing terminal).

The network 18 is, for example, one or more local area networks (LANs) inside the firewall. In another example, the network 18 includes the Internet that is outside the firewall in addition to the LAN. In still another example, the network 18 further includes a virtual private network (VPN) and/or a wide-area Ethernet (registered trademark). The network 18 is any one of a wired network, a wireless network, and a combination of the wired network and the wireless network. In a case where the content management server 10, the personal terminal 12, the stationary terminal 14 or the cloud storage service 16 connects to the network 18 through a mobile phone network such as 3G, Long Term Evolution (LTE), 4G, the LAN can be omitted.

Hardware Configuration:

Hardware Configuration of Computer:

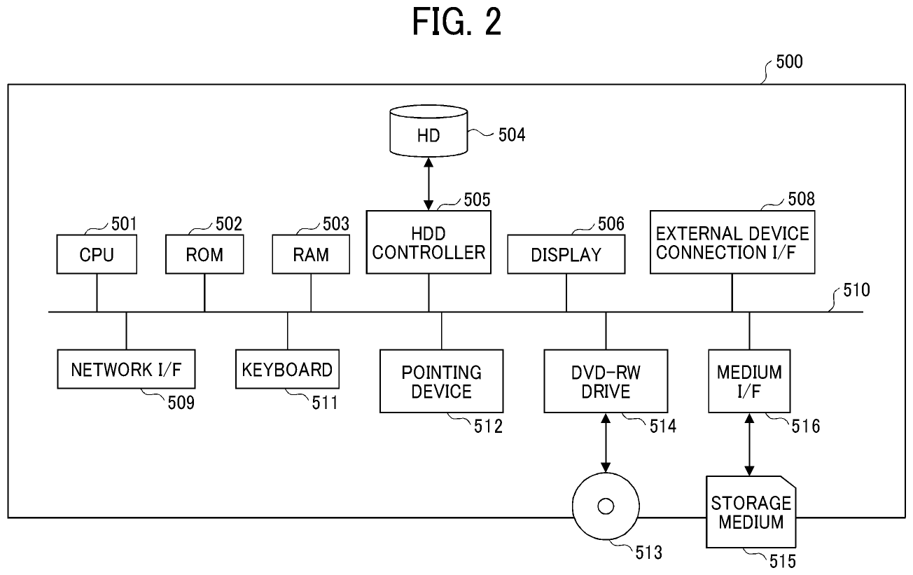

Each of the content management server 10 and the cloud storage service 16 is implemented by, for example, a computer 500 having a hardware configuration illustrated in FIG. 2. Further, when each of the personal terminal 12 and the stationary terminal 14 is a PC, which is an example of an information processing terminal, the PC is also implemented, for example, by the computer 500 having a hardware configuration illustrated in FIG. 2.

FIG. 2 is a block diagram illustrating an example of a hardware configuration of the computer 500, according to the present embodiment. As illustrated in FIG. 2, the computer 500 includes a central processing unit (CPU) 501, a read only memory (ROM) 502, a random access memory (RAM) 503, a hard disc (HD) 504, a hard disc drive (HDD) controller 505, a display 506, an external device connection interface (I/F) 508, a network I/F 509, a data bus 510, a keyboard 511, a pointing device 512, a digital versatile disc-rewritable (DVD-RW) drive 514, and a medium I/F 516.

The CPU 501 controls entire operation of the computer 500. The ROM 502 stores a program such as an initial program loader (IPL) to boot the CPU 501. The RAM 503 is used as a work area for the CPU 501. The HD 504 stores various data such as a program. The HDD controller 505 controls reading and writing of various data from and to the HD 504 under control of the CPU 501.

The display 506 displays various information such as a cursor, menu, window, character, or image. The external device connection I/F 508 is an interface that connects the computer 500 to various external devices. Examples of the external devices include a universal serial bus (USB) memory and a printer. The network I/F 509 is an interface that controls communication of data through the network 18. Examples of the data bus 510 include an address bus and a data bus, which electrically connects the elements such as the CPU 501 with one another.

The keyboard 511 is one example of an input device (input means) provided with a plurality of keys for allowing a user to input characters, numerals, or various instructions. The pointing device 512 is an example of an input device (input means) that allows a user to select or execute a specific instruction, select a target for processing, or move a cursor being displayed. The DVD-RW drive 514 reads and writes various data from and to a DVD-RW 513, which is an example of a removable storage medium. The removable storage medium is not limited to the DVD-RW and may be a digital versatile disc-recordable (DVD-R) or the like. The medium I/F 516 controls reading and writing (storing) of data from and to a storage medium 515 such as a flash memory.

Overview of Functions of Information Processing System During Meeting:

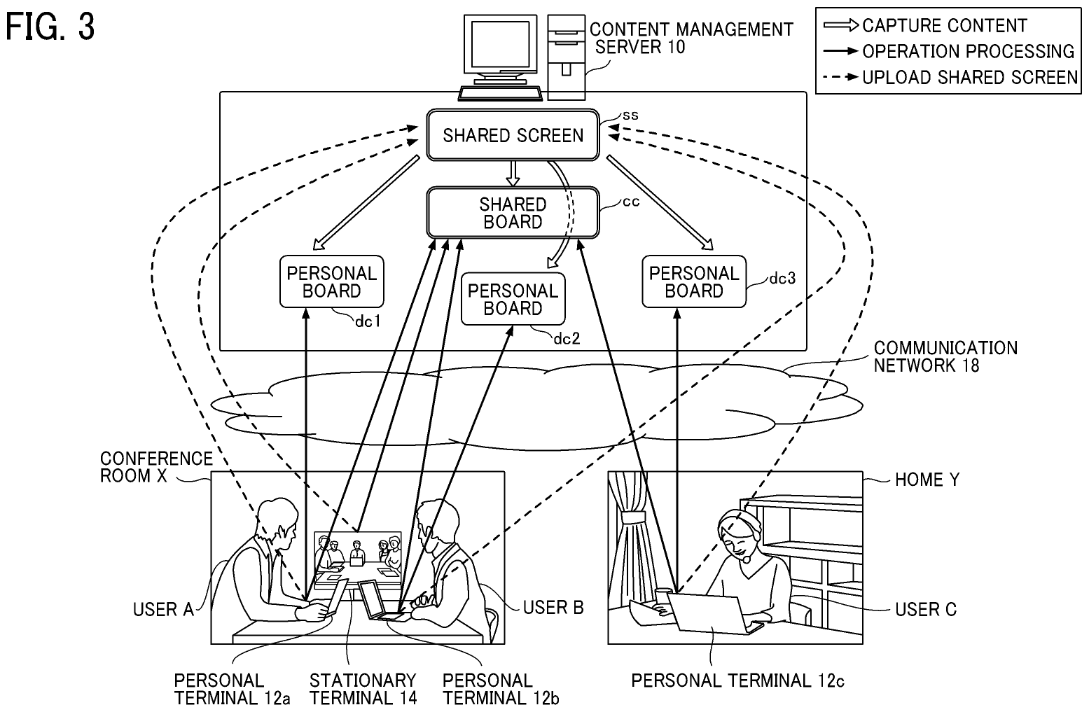

FIG. 3 is a schematic diagram illustrating an overview of how the information processing system 1 operates during a meeting. FIG. 3 illustrates a case in which a meeting participant A and a meeting participant B who are in a conference room X of a company and a meeting participant C who is at a home Y are conducting a remote meeting by using the information processing system 1.

The meeting participant A uses a personal terminal 12a in the conference room X, and the meeting participant B uses a personal terminal 12b in the conference room X. Further, the stationary terminal 14 that is shareable by plural meeting participants is provided in the conference room X. The meeting participant C uses a personal terminal 12c at the home Y. In the following description, the personal terminal 12a, the personal terminal 12b, and the personal terminal 12c are collectively referred to as simply a “personal terminal 12” or “personal terminals 12”, unless these terminals need to be distinguished from each other.

The content management server 10 is a computer functioning as a web server (or HTTP server) that stores and manages data of contents to be transmitted to the personal terminal 12 and the stationary terminal 14.

The content management server 10 stores storage locations (or storage areas) for implementing a shared screen ss, a shared board CC, and a personal board DC, which will be described later. The personal board DC is provided for each of meeting participants. Specifically, only the personal terminal 12a, the personal terminal 12b and the personal terminal 12c can access a personal board DC1, a personal board DC2 and a personal board DC3, respectively. The personal board DC is an electronic space dedicated to each of the meeting participants. The personal terminal 12 of each meeting participant can access only the personal board DC dedicated to the corresponding meeting participant, which allows the corresponding meeting participant to draw characters or strokes by hand or arrange objects on the accessed personal board DC.

The shared board CC is shared by the meeting participants, whereby strokes or characters drawn by one or more of the meeting participants by hand or objects arranged by one or more of the meeting participants on the shared board CC are shared. Specifically, any of the personal terminal 12a, the personal terminal 12b and the personal terminal 12c can access the shared board CC, which allows the meeting participants of the personal terminal 12a, the personal terminal 12b and the personal terminal 12c to share strokes or characters handwritten by the meeting participants or objects arranged by the meeting participants on the shared board CC. The shared screen ss is a computer screen such as an application screen shared by the meeting participants.

The content management server 10 stores, for each of meetings, information (data) such as contents developed on the shared screen ss, the shared board CC, and the personal board DC in association with the corresponding meeting. Thereby, even when the content management server 10 manages multiple meetings, data of content are not communicated over different meetings.

Each personal terminal 12 causes a web application operating on a web browser installed in the personal terminal 12 to display content of the personal board DC, the shared board CC and the shared screen ss of a meeting in which the meeting participant participates. Thus, the meeting participant can open a personal file with an application and share the screen of the opened file on the shared screen ss, share handwritten strokes or characters or object arrangement on the shared board, or keep handwritten strokes or characters or object arrangement on the personal board DC as a personal memo.

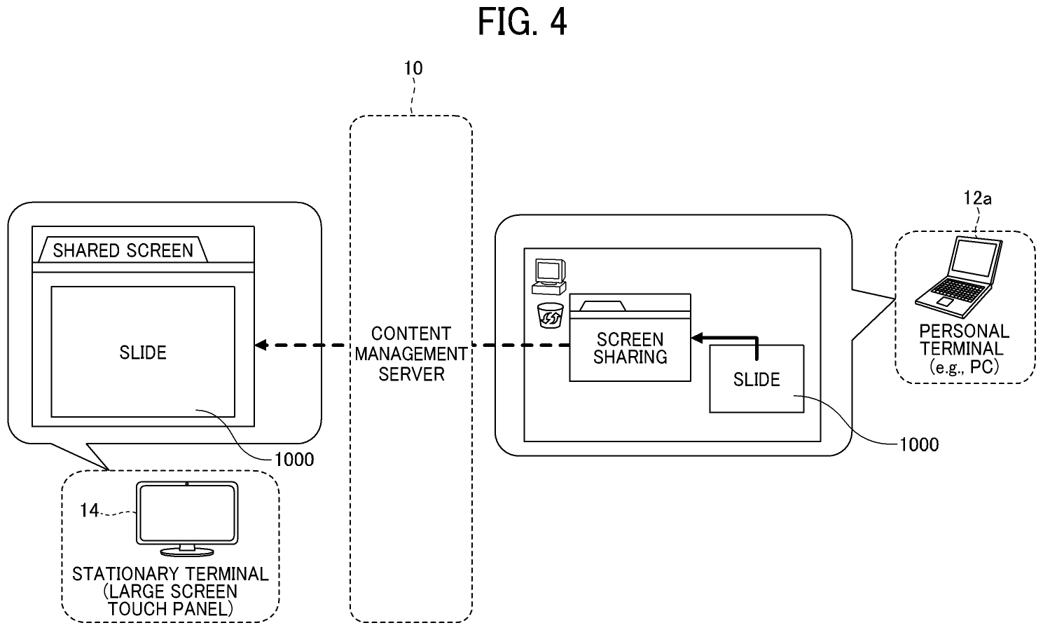

FIG. 4 is an example illustration for explaining a screen sharing function. FIG. 4 illustrates an example in which a meeting participant who operates the personal terminal 12a opens a desired file whose screen is to be shared, displays a computer screen 1000 corresponding to a type of the file, and uses a screen sharing function. The personal terminal 12 and the stationary terminal 14 associated with the meeting can share the screen of the computer screen 1000 on the shared screen ss. Note that the screen sharing of the computer screen 1000 on the shared screen ss can be performed by using streaming or the like from the content management server 10 to the personal terminal 12 or the stationary terminal 14.

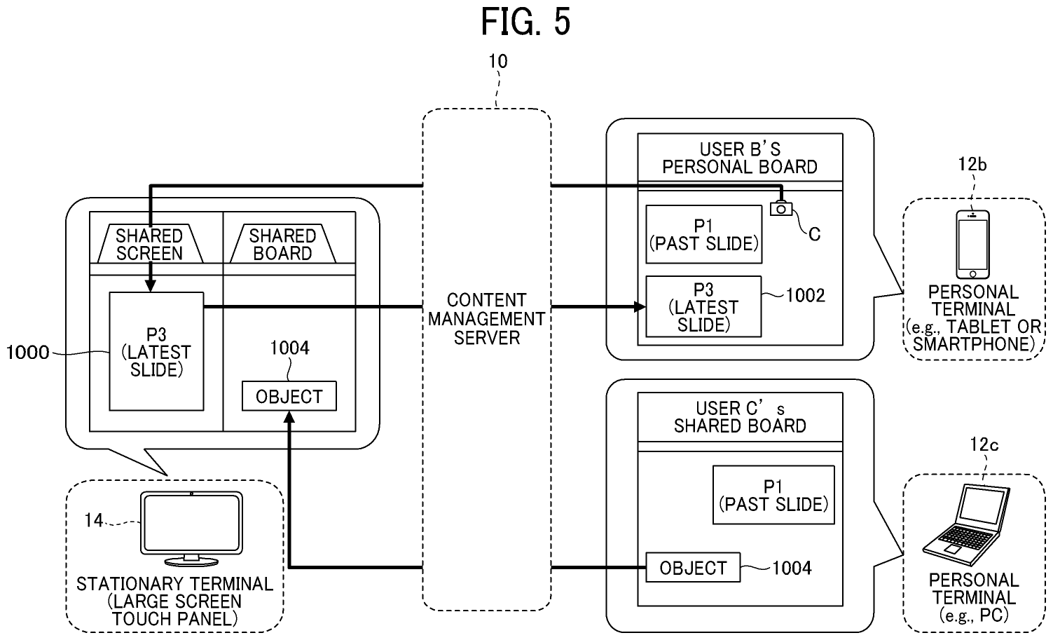

FIG. 5 is an example illustration for explaining a shared board function and a personal board function. The meeting participant B, who operates the personal terminal 12b, selects (e.g., taps or clicks) a capture button C on the personal board DC, to arrange the computer screen 1000 displayed on the shared screen ss on the personal board DC as an object 1002.

The meeting participant C, who operates the personal terminal 12c, performs an operation of arranging an object 1004 on the shared board CC, to cause the object 1004 arranged on the shared board CC to be shared by the personal terminal 12 and the stationary terminal 14 associated with the meeting.

In the information processing system 1 according to the present embodiment, the screen sharing function described above is used to screen-share a file stored in the cloud storage service 16. Further, in the information processing system 1 according to the present embodiment, the above-described shared board function is used, to share the history of the file that was screen-shared as the object 1004 on the shared board CC.

Functional Configuration:

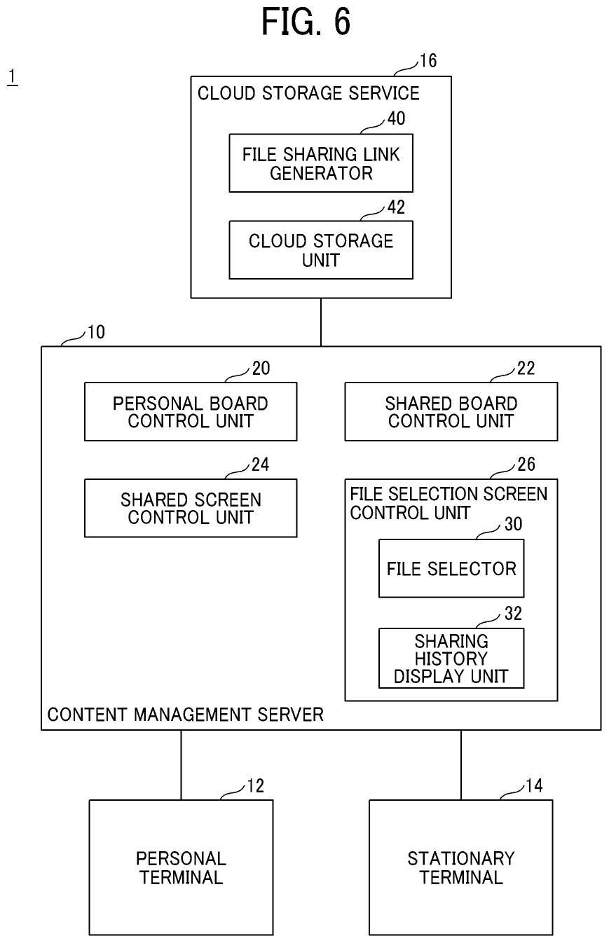

A description is now given of a functional configuration of the information processing system 1, with reference to FIG. 6. FIG. 6 is a block diagram illustrating an example of a functional configuration of the information processing system 1.

The content management server 10 includes, for example, a personal board control unit 20, a shared board control unit 22, a shared screen control unit 24, and a file selection screen control unit 26. The file selection screen control unit 26 includes a file selector 30 and a sharing history display unit 32. These units are functions or means implemented by or caused to function by operating one or more hardware components illustrated in FIG. 2 in cooperation with instructions of the CPU 501 according to the program loaded from the HD 504 to the RAM 503. The cloud storage service 16 includes a file sharing link generator 40 and a cloud storage unit 42.

The personal board control unit 20 of the content management server 10 performs control relating to the personal board DC. The shared board control unit 22 performs control relating to the shared board CC. The shared screen control unit 24 performs control relating to the shared screen ss. The file selection screen control unit 26 performs control to perform screen sharing of a file selected from a given personal terminal 12 on the shared screen ss and control to display the history of screen-shared files on the shared board CC.

The file selector 30 provides a function of allowing a user to select a file to be screen-shared on the shared screen ss. Further, the sharing history display unit 32 provides a function of causing a history of screen-shared files to be displayed on the shared board CC. The history of screen-shared file is generated by using a sharing link associated with the screen-shared file.

In the information processing system 1 according to the present embodiment, a description is given of an example in which a meeting participant selects a file stored in the cloud storage as an example of a file to be screen-shared on the shared screen ss. In this case, the sharing link is, for example, a uniform resource locator (URL) for sharing a file stored in the cloud storage, and is used to give permission for the meeting participant who knows the URL to display the file.

The cloud storage unit 42 performs control relating to the cloud storage. The file sharing link generator 40 generates a sharing link for sharing a file stored in the cloud storage and provides the generated sharing link to the content management server 10.

In the information processing system 1 according to the present embodiment, the description given above is of an example case in which a meeting participant selects a desired file stored in the cloud storage as an example file to be screen-shared on the shared screen ss. However, the cloud storage is just an example. Any suitable storage other than the cloud storage can be used, such as a storage of the content management server 10, provided that the storage can generate a sharing link for sharing a file.

For example, in the information processing system 1 as illustrated in FIG. 6, the meeting participant A, who is to share a screen of a file, accesses the content management server 10 from the personal terminal 12a. The personal terminal 12a displays the personal board DC. The meeting participant A performs an operation for starting screen sharing of the file from the personal board DC.

On the personal board DC of the meeting participant A, a file selection screen for files for which the meeting participant A has access authorization is displayed. In the present embodiment, the file selection screen for files stored in the cloud storage service 16 is displayed. The meeting participant A performs an operation of selecting a file to be screen-shared from the file selection screen.

The file selected from the file selection screen is displayed on the shared screen ss, whereby the selected file is screen-shared by the personal terminal 12a of the meeting participant A, the personal terminal 12b of the meeting participant B, and the personal terminal 12c of the meeting participant C and the stationary terminal 14. Further, the sharing link of the file selected from the file selection screen is displayed on the shared board CC as the history of the file that was screen-shared.

Since the shared board CC is shared by the meeting participants and can be displayed even after the meeting ends. Therefore, the meeting participants can check the files that was screen-shared during the meeting even after the meeting ends.

Processes or Operation:

A description is given below of processes or operation performed by the information processing system 1 according to the present embodiment. In this embodiment, first, a meeting is generated, and then, the shared screen ss, shared board CC, and personal board DC of the meeting are generated. Thereafter, the generated shared screen ss, shared board CC, and personal board of the meeting are displayed at personal terminal 12 and the stationary terminal 14.

For example, a meeting participant participates in a meeting by entering a connection address to the meeting into a web browser, to cause the shared screen ss, shared board CC, and personal board DC of the meeting to be displayed at the personal terminal 12 and the stationary terminal 14.

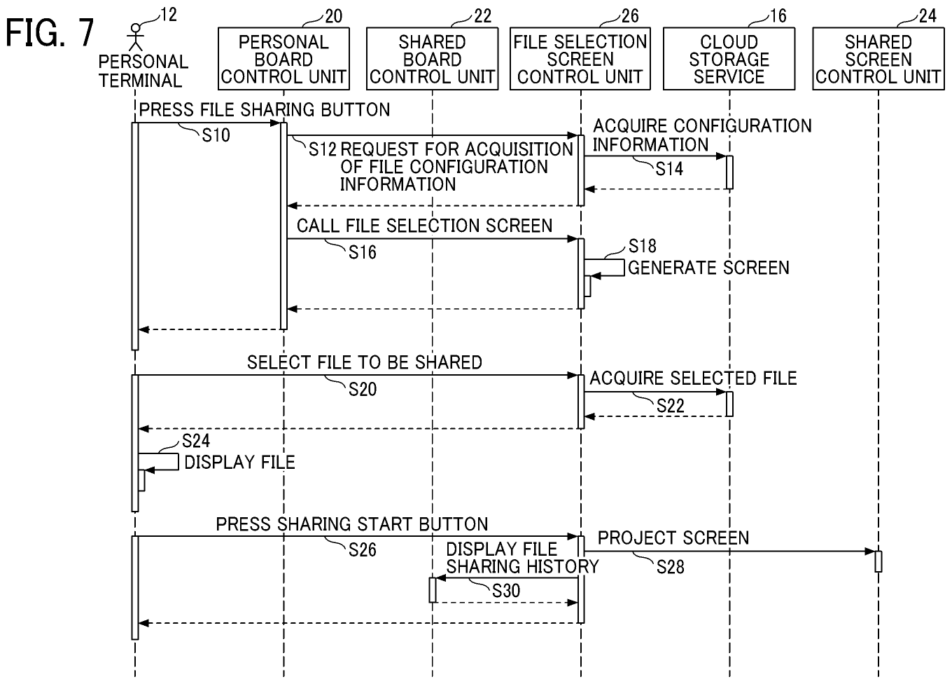

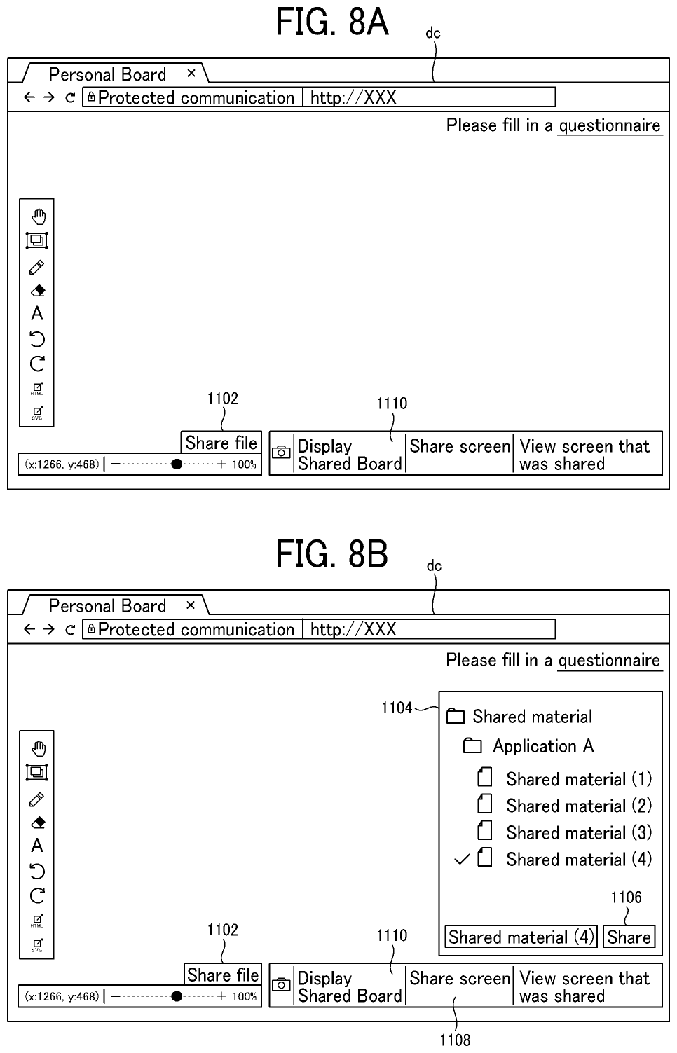

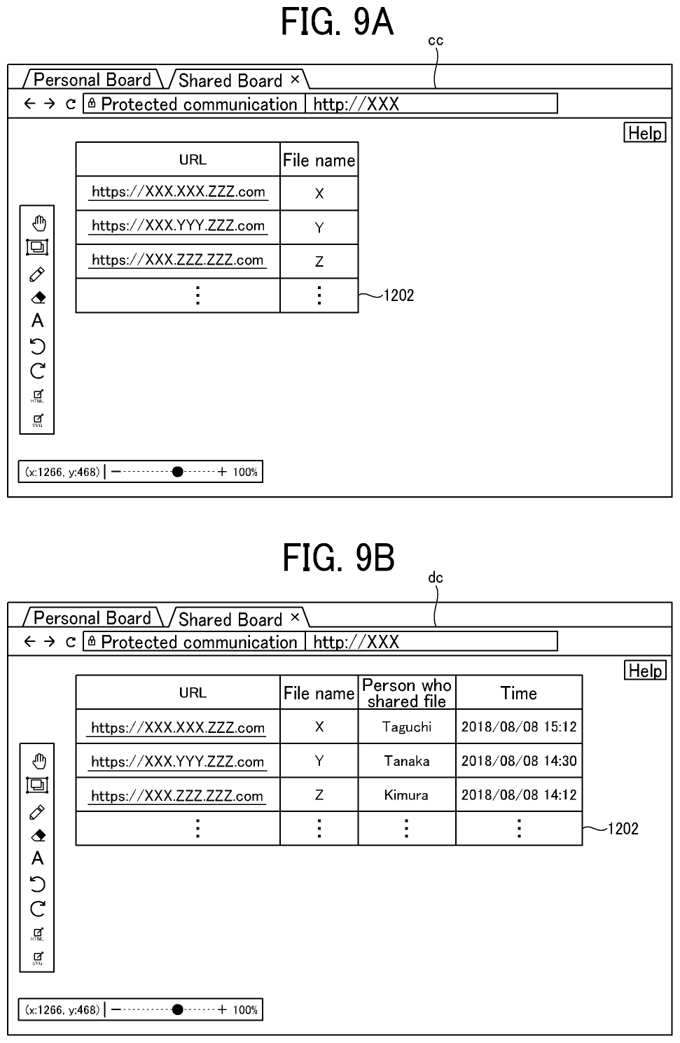

FIG. 7 is a sequence diagram illustrating an example of operation executed by the information processing system 1 according to the present embodiment. FIG. 8A and FIG. 8B are diagrams, each illustrating an example of a screen of the personal board DC. FIG. 9A and FIG. 9B are diagrams, each illustrating an example of a screen of the shared board CC.

In step S10, for example, the meeting participant A, who is to start screen sharing of a file, presses a “Share file” button 1102 on the personal board DC illustrated in FIG. 8A displayed on the personal terminal 12a. In step S12, the personal board control unit 20 of the content management server 10 sends a request for acquiring file configuration information to the file selection screen control unit 26.

In step S14, in response to receiving the request for acquiring file configuration information, the file selection screen control unit 26 acquires the file configuration information from the cloud storage service 16 that is available to the meeting participant A. Further, the file selection screen control unit 26 sends a notification indicating that the acquisition of the file configuration information is completed to the personal board control unit 20. In step S16, the personal board control unit 20 calls a file selection screen 1104 from the file selection screen control unit 26. In step S18, the file selection screen control unit 26 generates the file selection screen 1104 as illustrated in FIG. 8B based on the file configuration information acquired in step S14, and displays the file selection screen 1104 on the personal terminal 12a of the meeting participant A.

In step S20, the meeting participant A selects a desired file for which he or she wants to start screen sharing from the file selection screen 1104 and presses a “Share” button 1106. In step S22, in response to receiving the pressing of the “Share” button 1106, the file selection screen control unit 26 acquires the file selected from the file selection screen 1104 from the cloud storage service 16.

The file selection screen control unit 26 transmits the file acquired in step S22 to the personal terminal 12a of the meeting participant A. In step S24, the personal terminal 12a activates the file received from the file selection screen control unit 26 with an application program corresponding to the file, to display the file.

In step S26, the meeting participant A presses a “Share screen” button 1108 illustrated in FIG. 8B. The “Share screen” button 1108 is an example of a sharing start button for starting screen sharing. When the file selection screen control unit 26 receives information indicating that the “Share screen” button 1108 is pressed, the operation proceeds to step S28.

In step S28, the file selection screen control unit 26 requests the shared screen control unit 24 to project a screen of the file displayed on the personal terminal 12a in step S24 onto the shared screen ss. The shared screen control unit 24 displays, on the shared screen ss, the file for which projection onto the shared screen ss is requested. Thus, the information processing system 1 according to the present embodiment displays the file stored in the cloud storage service 16 on the shared screen ss, so that the file is screen-shared.

Further, in step S30, the file selection screen control unit 26 generates a file sharing history display screen 1202 that displays the history of screen-shared files. Then, the file selection screen control unit 26 requests the shared board control unit 22 to display the generated file sharing history display screen 1202 on the shared board CC.

The request in step S30 causes the shared board CC displayed by the shared board control unit 22 to include the file sharing history display screen 1202, as illustrated in FIG. 9A and FIG. 9B. FIG. 9A illustrates an example of the file sharing history display screen 1202 that includes a URL and a file name as items. The URL is an example of a sharing link. FIG. 9B illustrates an example of the file sharing history display screen 1202 that includes a URL, a file name, a person who shared file, and time as items. The URL is an example of a sharing link. The file name is a name of a file that was screen-shared. The person who shared file is a meeting participant who selected a file and performs screen sharing. The time is the date and time when screen sharing was started.

When the meeting participant a “Display Shared Board” button 1110 on the personal board DC displayed on the personal terminal 12 after step S30, for example, the shared board CC including the file sharing history display screen 1202 as illustrated in FIG. 9A or FIG. 9B is displayed. Thus, the information processing system 1 according to the present embodiment display the history of the files that was screen-shared during the meeting on the shared board CC, so that the history is shared by the meeting participants.

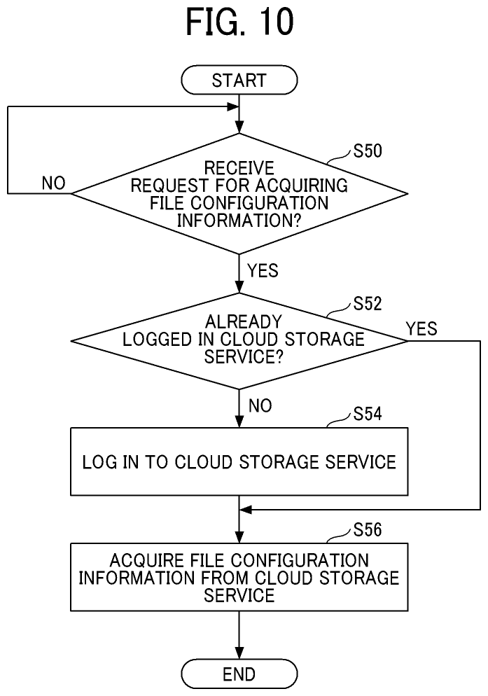

The process in step S14 performed by the file selection screen control unit 26 for acquiring the file configuration information from the cloud storage service 16 that is available to the meeting participant A is executed according to the flowchart illustrated in FIG. 10, for example. FIG. 10 is a flowchart illustrating an example of operation of acquiring the file configuration information from the cloud storage service 16, performed by the content management server 10.

When the file selection screen control unit 26 receives the request for acquiring file configuration information, the operation proceeds from step S50 to step S52. In step S52, the file selection screen control unit 26 determines whether the meeting participant A has logged in the cloud storage service 16. When the file selection screen control unit 26 determines that the meeting participant A has not yet logged in the cloud storage service 16 (S52: NO), the operation proceeds to step S54. In step S54, the file selection screen control unit 26 prompts the meeting participant A to log in the cloud storage service 16. When the file selection screen control unit 26 determines that the meeting participant has logged in the cloud storage service 16 (S52: YES), the process of step S54 is skipped.

In step S56, the file selection screen control unit 26 acquires file configuration information of one or more files that are available to the meeting participant A from the cloud storage service 16 in which the meeting participant A has logged in.

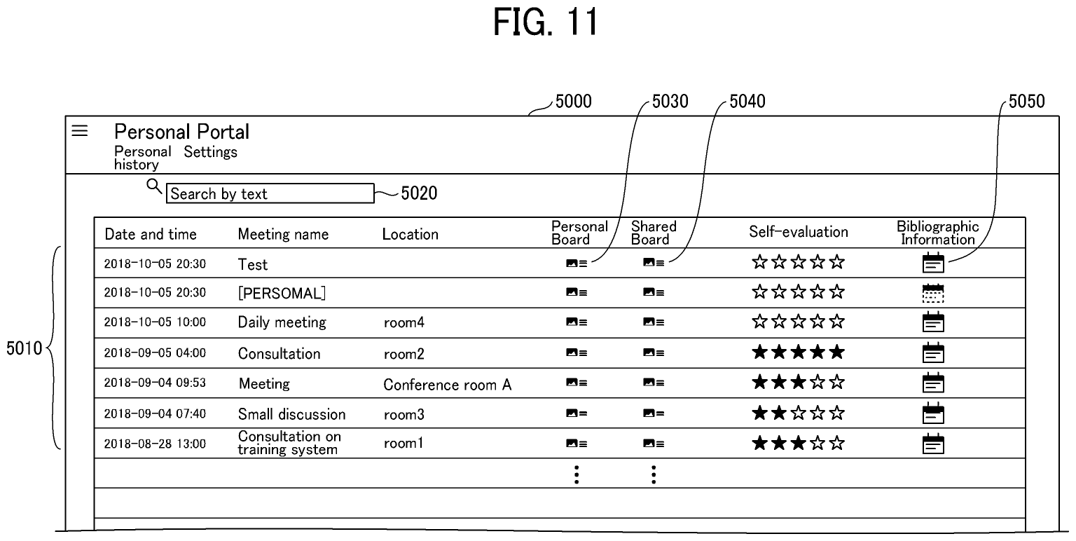

After the meeting ends, each meeting participant can check a file(s) that is screen-shared during the meeting as follows, for example. FIG. 11 is a diagram illustrating a display example of a personal portal screen. In the personal portal screen 5000 of FIG. 11, a meeting list 5010 listing meetings in which the meeting participant who operates the personal terminal 12 participated.

In the example of the meeting list 5010 illustrated in FIG. 11, a date and time, a meeting name, a location, a personal board button 5030, a shared board button 5040, a self-evaluation, and bibliographic information button 5050 are displayed as items for each meeting. The meeting participant views the personal portal screen 5000 as illustrated in FIG. 11 to check the meeting list 5010 listing meetings in which he or she participated. The self-evaluation is an example of evaluation information.

The personal board button 5030 is linked to a personal board screen that displays the personal board DC of the corresponding meeting. The shared board button 5040 is linked to a shared board screen that displays the shared board CC of the corresponding meeting. The bibliographic information button 5050 is linked to a bibliographic information display screen that displays bibliographic information of the corresponding meeting.

The personal portal screen 5000 includes a search field 5020 that receives a search request by text from the meeting participant. The meeting participant who operates the personal terminal 12 enters desired text in the search field 5020 to retrieve a meeting(s) with which associated personal board DC, shared board CC, or bibliographic information includes the text entered in the search field 5020, so that the retrieved meeting(s) is displayed.

The meeting participant who operates the personal terminal 12 can cause the personal portal screen 5000 to transition to a shared board screen displaying the shared board CC as illustrated in FIG. 9A and FIG. 9B, so that the file sharing history display screen 1202 included in the shared board CC of FIG. 9A and FIG. 9B is displayed. Therefore, even after a meeting ends, the meeting participant can check one or more files that were screen-shared during the meeting by the history of files that were screen-shared listed in the file sharing history display screen 1202. The meeting participant can use the information on the shared board CC as, for example, minutes.

A remote conference system of the related art is silent about that a user checks meeting materials shared in the past meeting at a desired timing other than during the meeting, such as after the meeting.

According to one or more embodiments of the present disclosure, a user can check one or more files that have been screen-shared by web browsers of a plurality of communication terminals after the screen sharing.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. The shared board CC is an example of a shared web page. The personal board DC is an example of an individual web page. The cloud storage service 16 is an example of a file storage area. The sharing link for sharing a file stored in the cloud storage is an example of shared link information.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

What is claimed is:

1. An information processing system comprising:
one or more information processing apparatuses each being configured to control a plurality of communication terminals to perform screen sharing by using web browsers installed in the plurality of communication terminals,
the one or more information processing apparatuses each including circuitry configured to:
receive a selection of a file to be screen-shared from one of the plurality of communication terminals; and
display a history of the file that is screen-shared on a shared web page, the shared web page being a web page editable from the web browsers of the plurality of communication terminals.

2. The information processing system of claim 1, wherein
the circuitry is further configured to control each one of the plurality of communication terminals to display a file selection screen for receiving the selection of the file to be screen-shared on a dedicated individual web page editable from the web browser of each of the plurality of communication terminals.

3. The information processing system of claim 2, wherein
the circuitry is further configured to:
acquire information on the file from a file storage area that stores the file; and
control each of the plurality of communication terminals to display the file selection screen based on the acquired information on the file.

4. The information processing system of claim 1, wherein
the circuitry is further configured to display, as the history of the file that is screen-shared, sharing link information associated with the file that is screen-shared.

5. The information processing system of claim 4, wherein
the circuitry is further configured to display, as the history of the file that is screen-shared, a name of a user who selected the file to be screen-shared.

6. The information processing system of claim 4, wherein
the circuitry is further configured to display, as the history of the file that is screen-shared, a time at which the selection of the file to be screen-shared is performed.

7. An information processing apparatus that controls a plurality of communication terminals to perform screen sharing by using web browsers installed in the plurality of communication terminals, the information processing apparatus comprising circuitry configured to:
receive selection of a file to be screen-shared from one of the plurality of communication terminals; and
display a history of the file that is screen-shared on a shared web page, the shared web page being a web page editable from the web browsers of the plurality of communication terminals.

8. An information processing method performed by an information processing apparatus that controls a plurality of communication terminals to perform screen sharing by using web browsers installed in the plurality of communication terminals, the method comprising:
receiving selection of a file to be screen-shared from one of the plurality of communication terminals; and
displaying a history of the file that is screen-shared on a shared web page, the shared web page being a web page editable from the web browsers of the plurality of communication terminals.
